(19) United States
(12) Patent Application Publication
(10) Pub. No.: US 2008/0317946 A1
(43) Pub. Date: Dec. 25, 2008

(54) FUEL CELL MEMBRANES, GELS, AND METHODS OF FABRICATION

(75) Inventor: Ru Chen, Portland, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: CLEAREDGE POWER, INC., Hillsboro, OR (US)

(21) Appl. No.: 12/107,670

(22) Filed: Apr. 22, 2008

Related U.S. Application Data
(60) Provisional application No. 60/945,517, filed on Jun. 21, 2007.

(51) Int. Cl. B05D 1/00; C08K 5/42

(52) U.S. Cl. 427/115; 524/157

(57) ABSTRACT

The forming of fuel cell membranes via novel intermediate gels is disclosed. One disclosed embodiment provides a method of making a fuel cell polyazole membrane comprising dissolving a polyazole with a water stable polyazole solubilizing acid thereby forming a polyazole-acid solution, applying a layer of said polyazole-acid solution to a support thereby forming a polyazole-acid film, contacting said polyazole-acid film with water thereby forming a polyazole-acid gel, and contacting said polyazole-acid gel with a doping acid thereby forming said fuel cell polyazole membrane.

### CROSS-REFERENCE TO RELATED APPLICATIONS

This application claims priority to U.S. Provisional Patent Application Ser. No. 60/945,517, filed Jun. 21, 2007, the disclosure of which is incorporated by reference in its entirety for all purposes.

### BACKGROUND

A typical fuel cell converts hydrogen and oxygen into water, producing electricity in the process. There are many potential uses for fuel cells, including automobiles and power plants, such as backup power supplies. One type of fuel cell is a proton exchange membrane fuel cell. A typical proton exchange membrane fuel cell includes a catalyst-coated membrane that is enclosed by flow field plates. For example, one side of the membrane acts as an anode, and is fed hydrogen gas. The other side of the membrane serves as the cathode, and is fed air to provide oxygen.

At the anode, a catalyst catalyzes a reaction wherein hydrogen molecules release their electrons and become hydrogen ions (protons). The protons pass through the membrane to reach the cathode. The electrons are forced to go around the membrane to the cathode (through an electric circuit), creating an electric current. At the cathode, another reaction takes place as the protons combine with oxygen to produce the fuel cell exhaust (water). The fuel cells produce direct current voltage that can be used directly or converted to alternating current for alternating current devices.

The fuel cell membrane material may be a polymer with chemically bonded acid groups (e.g., perfluorosulfonic acid). This type of membrane requires hydration to conduct protons, which limits the fuel cell operation temperature to usually around 80° C.-90° C. Alternatively, the polymer membrane may contain acid in a free form, such as polybenzimidazole doped with phosphoric acid. This type of membrane can be used in fuel cells operated at high temperatures (up to 200° C.) thereby providing high CO tolerance, fast electrochemical reaction kinetics, a water management-free system, favorable heat exchanger requirements, and higher quality waste heat.

Polybenzimidazole fabrication requires many tedious and time consuming steps. The conventional method to prepare fuel cell polybenzimidazole membranes require dissolving in lithium chloride/N,N-dimethyl acetamide solution at elevated temperatures. The polymer is then cast into thin films and washed thoroughly with water to remove the salt residue, dried in an oven, and doped with phosphoric acid over a prolonged period of time. The acid content is typically very low, as is the ionic conductivity compared with liquid electrolytes. An alternative method involves dissolving of polybenzimidazole in trifluoroacetic acid and phosphoric acid mixed solvent. The solution is cast into films, and the trifluoroacetic acid is evaporated at elevated temperatures. Trifluoroacetic acid is expensive and is unable to dissolve some types of polybenzimidazoles. Moreover, the solubility of polybenzimidazole decreases as the phosphoric acid content in the mixed solvent increases, thereby limiting the phosphoric acid content in the resulting membranes.

Another method of polybenzimidazole fuel cell fabrication involves polymerization of the polymer in polyphosphoric acid. The film is cast directly from the polymerization solution. The polyphosphoric acid is then hydrolyzed into phosphoric acid, resulting in polybenzimidazole containing phosphoric acid. The use of the polyphosphoric acid method is limited, however, because polyphosphoric acid is a poor solvent for polybenzimidazoles. Moreover, polyphosphoric acid is highly viscous and, therefore, requires casting temperatures above 200° C. Another problem is the poor synthesis efficiency of polybenzimidazole in polyphosphoric acid often resulting in less than 10% solid content in the films, and retaining low molecular polybenzimidazole or monomer residues in the resulting membranes.

### SUMMARY

Accordingly, efficient and economical methods of making fuel cell membranes and novel intermediate gels useful in the methods of fabricating the fuel cell membranes are disclosed herein. One embodiment provides a method of making a fuel cell polyazole membrane. This embodiment comprises dissolving a polyazole with a water stable polyazole solubilizing acid thereby forming a polyazole-acid solution. A layer of the polyazole-acid solution is applied to a support thereby forming a polyazole-acid film. The polyazole-acid film is contacted with water thereby forming a polyazole-acid gel. The polyazole-acid gel is contacted with a doping acid thereby forming the fuel cell polyazole membrane.

Another embodiment provides a method of making a fuel cell polyazole membrane comprising dissolving a polyazole with a water stable polyazole solubilizing acid thereby forming a polyazole-acid solution. A layer of the polyazole-acid solution is applied to a support thereby forming a polyazole-acid film. The polyazole-acid film is contacted with water thereby forming a polyazole-acid gel. The polyazole-solubilizing acid is flushed from the polyazole-acid gel with water thereby forming a polyazole-water gel. The polyazole-water gel is contacted with a doping acid thereby forming the fuel cell polyazole membrane.

Another embodiment provides a gel comprising a polyazole and one or more of sulfonic acid, methane sulfonic acid, trifluoromethane sulfonic acid, trifluoromethane carboxylic acid, benzene sulfonic acid, chloro-sulfonic acid, and fluoro-sulfonic acid.

### BRIEF DESCRIPTION OF THE FIGURES

FIG. 1 shows a flow diagram depicting an embodiment of a method of forming a fuel cell membrane.

FIG. 2 shows a flow diagram depicting another embodiment of a method of forming a fuel cell membrane.

### DETAILED DESCRIPTION

### Abbreviations and Definitions

The abbreviations used herein have their conventional meaning within the chemical and biological arts.

The term “alkyl,” by itself or as part of another substituent, means, unless otherwise stated, a straight (i.e., unbranched) or branched chain, or combination thereof, which may be fully saturated, mono- or polyunsaturated and can include di- and multivalent radicals, having the number of carbon atoms designated (i.e., C₁-C₁₀ means one to ten carbons). Examples of saturated hydrocarbon radicals include, but are not limited to, groups such as methyl, ethyl, npropyl, isopropyl, n-butyl, t-butyl, isobutyl, sec-butyl, (cyclohexyl)methyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2(butadienyl), 2,4-pentadienyl, 3-(1,4-pentadienyl), ethynyl, 1- and 3-propynyl, 3-butynyl, and the higher homo logs and isomers.

The term “heteroalkyl,” by itself or in combination with another term, means, unless otherwise stated, a stable straight or branched chain, or cyclic hydrocarbon radical, or combinations thereof, comprising at least one carbon atom and at least one heteroatom selected from O, N, P, Si and S, and wherein the nitrogen and sulfur atoms may optionally be oxidized and the nitrogen heteroatom may optionally be quaternized. The heteroatom(s) O, N, P and S and Si may be placed at any interior position of the heteroalkyl group or at the position at which the alkyl group is attached to the remainder of the molecule. Examples include, but are not limited to, —CH₂—CH₂—O—CH₃, —CH₂—CH₂—NH—CH₃, —CH₂—CH₂—N(CH₃)—CH₃, —CH₂—S—CH₂—CH₃, —CH₂—CH₂—S(O)—CH₃, —CH₂—CH₂—S(O)₂—CH₃, —CH═CH—O—CH₃, —Si(CH₃)₃, —CH₂—CH═N—OCH₃, —CH═CH—N(CH₃)—CH₃, —O—CH₃, —O—CH₂—CH₃, and —CN. Up to two heteroatoms may be consecutive, such as, for example, —CH₂—NH—OCH₃ and —CH₂—O—Si(CH₃)₃. As described above, heteroalkyl groups, as used herein, include those groups that are attached to the remainder of the molecule through a heteroatom, such as —C(O)R′, —C(O)NR′, —NR′R″, —OR′, —SR′, and/or —SO₂R′. Where “heteroalkyl” is recited, followed by recitations of specific heteroalkyl groups, such as —NR′R″ or the like, it will be understood that the terms heteroalkyl and —NR′R″ are not redundant or mutually exclusive. Rather, the specific heteroalkyl groups are recited to add clarity. Thus, the term “heteroalkyl” should not be interpreted herein as excluding specific heteroalkyl groups, such as —NR′R″ or the like.

The terms “cycloalkyl” and “heterocycloalkyl”, by themselves or in combination with other terms, represent, unless otherwise stated, cyclic versions of “alkyl” and “heteroalkyl”, respectively. Additionally, for heterocycloalkyl, a heteroatom can occupy the position at which the heterocycle is attached to the remainder of the molecule. Examples of cycloalkyl include, but are not limited to, cyclopentyl, cyclohexyl, 1-cyclohexenyl, 3-cyclohexenyl, cycloheptyl, and the like. Examples of heterocycloalkyl include, but are not limited to, 1-(1,2,5,6-tetrahydropyridyl), 1-piperidinyl, 2-piperidinyl, 3-piperidinyl, 4-morpholinyl, 3-morpholinyl, tetrahydrofuran-2-yl, tetrahydrofuran-3-yl, tetrahydrothien-2-yl, tetrahydrothien-3-yl, 1-piperazinyl, 2-piperazinyl, and the like.

The terms “halo” or “halogen,” by themselves or as part of another substituent, mean, unless otherwise stated, a fluorine, chlorine, bromine, or iodine atom. Additionally, terms such as “haloalkyl,” are meant to include monohaloalkyl and polyhaloalkyl. For example, the term “halo(C₁-C₄)alkyl” is mean to include, but not be limited to, trifluoromethyl, 2,2,2-trifluoroethyl, 4-chlorobutyl, 3-bromopropyl, and the like.

The term “aryl” means, unless otherwise stated, a polyunsaturated, aromatic, hydrocarbon substituent which can be a single ring or multiple rings (preferably from 1 to 3 rings) which are fused together or linked covalently. The term “heteroaryl” refers to aryl groups (or rings) that contain from one to four heteroatoms selected from N, O, and S, wherein the nitrogen and sulfur atoms are optionally oxidized, and the nitrogen atom(s) are optionally quaternized. A heteroaryl group can be attached to the remainder of the molecule through a carbon or heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl and heteroaryl ring systems are selected from the group of acceptable substituents described below.

The term “oxo” as used herein means an oxygen that is double bonded to a carbon atom.

Substituents for the aryl and heteroaryl groups are varied and are selected from, for example: —OR′, —NR′R″, —SR′, -halogen, —SiR′R″ R′″, —OC(O)R′, —C(O)R′, —CO₂R′, CONR′R″, —OC(O)NR′R″, —NR″C(O)R′, —NR′—C(O)NR″R′″, —NR″C(O)₂R′, —NR—C(NR′R″R′″)=NR″″, —NR—C(NR′R″)=NR′″, —S(O)R′, —S(O)₂R′, —S(O)₂NR′R″, —NRSO₂R′, —CN and —NO₂, —R′, —N₃, —CH(Ph)₂, fluoro(C₁-C₄)alkoxy, and fluoro(C₁-C₄)alkyl, in a number ranging from zero to the total number of open valences on the aromatic ring system; and where R′, R″, R′″ and R″″ are preferably independently selected from hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl and substituted or unsubstituted heteroaryl.

Two of the substituents on adjacent atoms of the aryl or heteroaryl ring may optionally form a ring of the formula -T-C(O)—(CRR′)_{q}—U—, wherein T and U are independently —NR—, —O—, —CRR′— or a single bond, and q is an integer of from 0 to 3. Alternatively, two of the substituents on adjacent atoms of the aryl or heteroaryl ring may optionally be replaced with a substituent of the formula -A-(CH₂)ᵣ—B—, wherein A and B are independently —CRR′—, —O—, —NR—, —S—, —S(O)—, —S(O)₂—, —S(O)₂NR′— or a single bond, and r is an integer of from 1 to 4. One of the single bonds of the new ring so formed may optionally be replaced with a double bond. Alternatively, two of the substituents on adjacent atoms of the aryl or heteroaryl ring may optionally be replaced with a substituent of the formula —(CRR′)ₛ—X′—(C″R′″)_{d}—, where s and d are independently integers of from 0 to 3, and X′ is —O—, —NR′—, —S—, —S(O)—, —S(O)₂—, or —S(O)₂NR′—. The substituents R, R′, R″ and R′″ are preferably independently selected from hydrogen, substituted or unsubstituted alkyl, substituted or unsubstituted cycloalkyl, substituted or unsubstituted heterocycloalkyl, substituted or unsubstituted aryl, and substituted or unsubstituted heteroaryl.

As used herein, the term “heteroatom” or “ring heteroatom” is meant to include oxygen (O), nitrogen (N), sulfur (S), phosphorus (P), and silicon (Si).

A “substituent group,” as used herein, means a group selected from the following moieties:

(A) —OH, —NH₂, —SH, —CN, —CF₃, —NO₂, oxo, halogen, unsubstituted alkyl, unsubstituted heteroalkyl, unsubstituted cycloalkyl, unsubstituted heterocycloalkyl, unsubstituted aryl, unsubstituted heteroaryl, and

(B) alkyl, heteroalkyl, cycloalkyl, heterocycloalkyl, aryl, and heteroaryl, substituted with at least one substituent selected from:

(i) oxo, —OH, —NH₂, —SH, —CN, —CF₃, —NO₂, halogen, unsubstituted alkyl, unsubstituted heteroalkyl, unsubstituted cycloalkyl, unsubstituted heterocycloalkyl, unsubstituted aryl, unsubstituted heteroaryl, and

(ii) alkyl, heteroalkyl, cycloalkyl, heterocycloalkyl, aryl, and heteroaryl, substituted with at least one substituent selected from:

(a) oxo, —OH, —NH₂, —SH, —CN, —CF₃, —NO₂, halogen, unsubstituted alkyl, unsubstituted heteroalkyl, unsubstituted cycloalkyl, unsubstituted heterocycloalkyl, unsubstituted aryl, unsubstituted heteroaryl, and

(b) alkyl, heteroalkyl, cycloalkyl, heterocycloalkyl, aryl, or heteroaryl, substituted with at least one substituent selected from oxo, —OH, —NH₂, —SH, —CN, —CF₃, —NO₂, halogen, unsubstituted alkyl, unsubstituted heteroalkyl, unsubstituted cycloalkyl, unsubstituted heterocycloalkyl, unsubstituted aryl, and unsubstituted heteroaryl.

A “size-limited substituent” or “size-limited substituent group,” as used herein means a group selected from all of the substituents described above for a “substituent group,” wherein each substituted or unsubstituted alkyl is a substituted or unsubstituted C₁-C₂₀ alkyl, each substituted or unsubstituted heteroalkyl is a substituted or unsubstituted 2 to 20 membered heteroalkyl, each substituted or unsubstituted cycloalkyl is a substituted or unsubstituted C₄-C₈ cycloalkyl, and each substituted or unsubstituted heterocycloalkyl is a substituted or unsubstituted 4 to 8 membered heterocycloalkyl.

A “lower substituent” or “lower substituent group,” as used herein means a group selected from all of the substituents described above for a “substituent group,” wherein each substituted or unsubstituted alkyl is a substituted or unsubstituted C₁-C₈ alkyl, each substituted or unsubstituted heteroalkyl is a substituted or unsubstituted 2 to 8 membered heteroalkyl, each substituted or unsubstituted cycloalkyl is a substituted or unsubstituted C₅-C₇ cycloalkyl, and each substituted or unsubstituted heterocycloalkyl is a substituted or unsubstituted 5 to 7 membered heterocycloalkyl.

### Methods of Making Fuel Cell Polyazole Membranes

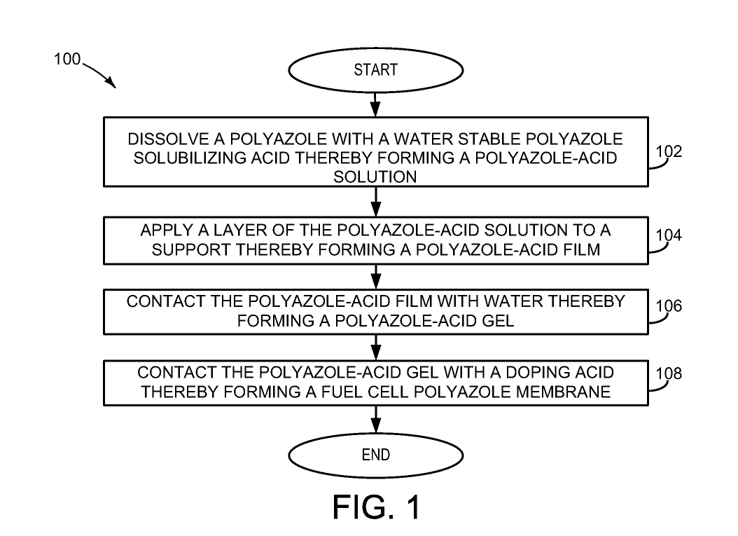

FIG. 1 shows a flow diagram depicting one embodiment of a method 100 of making a fuel cell polyazole membrane. The method may comprise, at 102, dissolving a polyazole with a water stable polyazole solubilizing acid thereby forming a polyazole-acid solution. A layer of the polyazole-acid solution is applied, at 104, to a support thereby forming a polyazole-acid film. The polyazole-acid film is contacted, at 106, with water thereby forming a polyazole-acid gel. The polyazole-acid gel is contacted, at 108, with a doping acid thereby forming the fuel cell polyazole membrane.

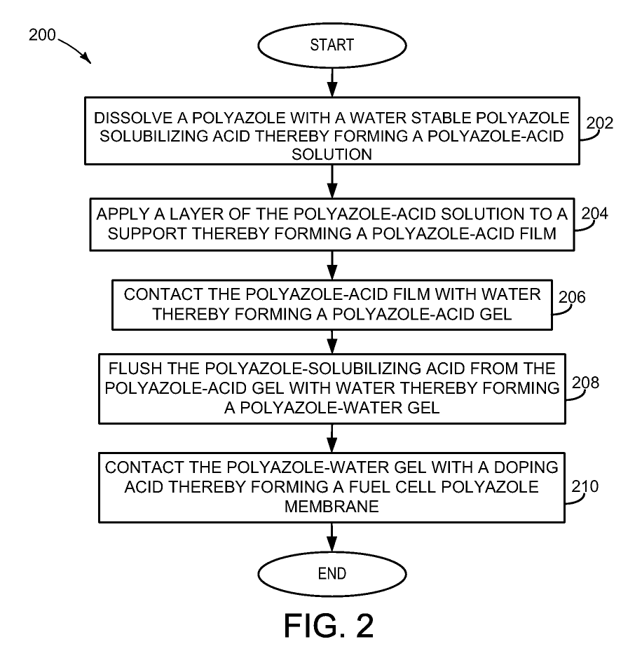

FIG. 2 shows a flow diagram depicting another embodiment of a method 200 of making a fuel cell polyazole membrane. The method 200 includes dissolving a polyazole with a water stable polyazole solubilizing acid, at 202, thereby forming a polyazole-acid solution. A layer of the polyazole-acid solution is applied, at 204, to a support thereby forming a polyazole-acid film. The polyazole-acid film is contacted with water, at 206, thereby forming a polyazole-acid gel. The polyazole-solubilizing acid is flushed from the polyazole-acid gel with water, at 208, thereby forming a polyazole-water gel. The polyazole-water gel is contacted with a doping acid thereby forming the fuel cell polyazole membrane.

Polyazoles useful in the disclosed embodiments include polymers comprising recurring azole containing units (i.e., a repeating polymer subunit containing at least one azole moiety). An azole moiety is a di-, tri-, or tetravalent azole radical. An “azole,” as used herein, refers to a five- or six-membered nitrogen-containing heterocycloalkyl or heteroaryl, including fused ring structures containing multiple rings. Useful polyazoles include those polymers having recurring units with the following azoles: benzimidazole (i.e. polybenzimidazole), imidazole (i.e. polyimidazole), triazole (i.e. polytriazole), benzotriazole (i.e. polybenzotriazole), pyridine (i.e. polypyridine), pyrazine (i.e. polypyrazine), pyrimidine (i.e. polypyrimidine), tetrazapyrene (i.e. polytetrapyrene), oxazole (i.e. polyoxazole), isoxazole (i.e. polyisoxazole), benzooxazole (i.e. polybenzoxazole), benzoxadiazole (i.e. polybenzoxadiazole), pyrazole (i.e. poly pyrazole), isothiazole (i.e. polyisothiazole), benzothiazole (i.e. polybenzothiazole), indazole (i.e. polyindazole), and quinoxazoline (i.e. polyquinoxazoline). In some embodiments, the polyazole is polybenzimidazole, polyimidazole, polybenzothiazole, polybenzoxazole, polyoxadiazole, polyquinoxaline, polythiadiazole, polypyridine, polypyrimidine, or polytetrazapyrene. In certain embodiments, the polyazole is polybenzimidazole. The polyazole may also be poly(2,2′-(1,4-phenylene)-5,5′-bibenzimidazole), poly(2,2′-(1,3-phenylene)-5,5′-bibenzimidazole), or poly(2,5-benzimidazole).

The azoles that from part or all of the recurring azole units may be unsubstituted (i.e., no substituents other than the chemical bonds to other recurring azole units, or to linkages to other recurring azole units). In other embodiments, the azole is substituted with —NH₂, —OH, oxo, halogen, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl. In some embodiments, each substituted group described above is substituted with at least one substituent group. More specifically, in some embodiments, each substituted alkyl, substituted heteroalkyl, substituted cycloalkyl, substituted heterocycloalkyl, substituted aryl, substituted heteroaryl described above is substituted with at least one substituent group. In other embodiments, at least one or all of these groups are substituted with at least one size-limited substituent group. Alternatively, at least one or all of these groups are substituted with at least one lower substituent group. In other embodiments, each substituted or unsubstituted alkyl is a substituted or unsubstituted C₁-C₂₀ alkyl, each substituted or unsubstituted heteroalkyl is a substituted or unsubstituted 2 to 20 membered heteroalkyl, each substituted or unsubstituted cycloalkyl is a substituted or unsubstituted C₄-C₈ cycloalkyl, and each substituted or unsubstituted heterocycloalkyl is a substituted or unsubstituted 4 to 8 membered heterocycloalkyl. Alternatively, each substituted or unsubstituted alkyl is a substituted or unsubstituted C₁-C₈ alkyl, each substituted or unsubstituted heteroalkyl is a substituted or unsubstituted 2 to 8 membered heteroalkyl, each substituted or unsubstituted cycloalkyl is a substituted or unsubstituted C₅-C₇ cycloalkyl, and each substituted or unsubstituted heterocycloalkyl is a substituted or unsubstituted 5 to 7 membered heterocycloalkyl.

In some embodiments, the doping acid forms part of an aqueous doping acid solution. An aqueous doping acid solution, as used herein, is a solution that includes water and a doping acid. A doping acid is a proton donating compound useful in proton conducting fuel cell membranes. Useful doping acids include, for example, phosphoric acid and sulfuric acid. Thus, in some embodiments, the aqueous doping acid solution is an aqueous phosphoric acid solution, or aqueous sulfuric acid solution.

According to some embodiments, the methods include the step of contacting a polyazole with a water stable polyazole solubilizing acid thereby forming a polyazole-acid solution. A water stable polyazole solubilizing acid is an acid that is capable of solubilizing the polyazole but does not hydrolyze upon contact with water. Hydrolysis reactions are well known in the chemical arts, and refer to reaction in which, formally, a water molecule splits a single reactant into two separate non-water product compounds containing a hydroxyl of the water molecule in one product compound and a hydrogen of the water molecule in the second product compound. Simply dissolving acid in water is not considered a hydrolysis reaction. But splitting polyphosphonic acid into phosphoric acid compounds using water is considered a hydrolysis reaction. Thus, polyphosphoric acid is not a water stable polyazole solubilizing acid.

In some embodiments, the water stable polyazole solubilizing acid comprises one or more of sulfonic acid, methane sulfonic acid, trifluoromethane sulfonic acid, trifluoromethane carboxylic acid, benzene sulfonic acid, chloro-sulfonic acid, and fluoro-sulfonic acid. In certain embodiments, the water stable polyazole solubilizing acid is methane sulfonic acid. In some embodiments, the water stable polyazole solubilizing acid has a pKa from 0 to −14. In other embodiments, the water stable polyazole solubilizing acid has a pKa from 0 to −5.

As described above, a water stable polyazole solubilizing acid is an acid that is capable of solubilizing a polyazole. In some embodiments, the water stable polyazole solubilizing acid is capable of solubilizing the polyazole, and thereby forming a polyazole-acid solution, at temperature below 200° C., below 150° C., or below 120° C. In some embodiments, the polyazole-acid solution is formed at a temperature from 20° C. to 120° C., from 80° C. to 120° C., or from 105° C. to 115° C.

Some embodiments also include the step of applying a layer of the polyazole-acid solution to a support thereby forming a polyazole-acid film. The polyazole-acid film is a liquid film (i.e. layer) comprising solubilized polyazole and the water stable polyazole solubilizing acid. The application of the layer to form the film may be carried out using techniques known in the art of membrane formation, such as casting, spraying, spreading by doctor blade, use of a Gardner knife, extrusion, etc. Supports are preferably chemically inert relative to the polyazole-acid solution and polyazole-acid film under application and film forming conditions. Any appropriate support material may be employed, such as glass or a polymer such as Teflon or a polyethylenephthalate polymer. Useful supports may be composed of materials including, but not limited to, polyethyleneterephthalate (PET), polytetrafluoroethylene (PTFE), polyhexafluoropropylene, copolymers of PTFE with hexafluoropropylene, polyimides, polyphenylene sulfides (PPS) and polypropylene (PP). The viscosity of the solution may be adjusted as required, for example, by addition of a volatile organic solvent. The thickness of the layer and/or film may be from 10 to 4000 μm, from 15 to 3500 μm, from 20 to 3000 μm, from 30 to 1500 μm, or from 50 to 1200 μm.

After formation of the polyazole-acid film, the film is contacted with water thereby forming a polyazole-acid gel. The polyazole-acid gel is a semisolid material comprising water, polyazole, and the water stable polyazole solubilizing acid. A variety of water contacting techniques are useful, such as applying liquid water to the film (e.g., dipping the film in liquid water, or spraying water onto the film), allowing the film to absorb water from the ambient air at room temperature, heating the film and/or the ambient air, allowing the film to absorb the water in the ambient air, etc. In certain embodiments, the humidity of the ambient air is adjusted in order to control the amount of time required to form the gel from the film.

In some embodiments, the polyazole-acid gel is contacted with a doping acid thereby forming the fuel cell polyazole membrane. Typically, by contacting the polyazole-acid gel with the doping acid, the water stable polyazole solubilizing acid is removed from the gel. For example, the polyazole-acid gel may be soaked in a liquid bath of doping acid (e.g., an aqueous doping acid solution). The water stable polyazole solubilizing acid may then exit the gel through diffusive force, or in some embodiments osmotic force. The doping acid may be in the form of an aqueous or non-aqueous solution. Where the doping acid is present as a non-aqueous solution, the non-aqueous solvent (e.g. alcohol) may be evaporated from the membrane.

In some embodiments, the water stable polyazole solubilizing acid is flushed from the polyazole-acid gel with water prior to adding the doping acid thereby forming a polyazole-water gel. Any appropriate flushing technique may be employed, including soaking the gel in a water bath. Fresh water may be continually or periodically introduced to the water bath, and the acid containing water may be continually or periodically removed, thereby flushing the acid from the gel with diffusive force. Alternatively, osmotic force may be used to flush the acid from the gel with water. The water may be pure water, or may be an aqueous solution, such as a buffered water solution. Finally, the polyazole-water gel is contacted with a doping acid (e.g., an aqueous or non-aqueous doping acid solution as described above) thereby forming the fuel cell polyazole membrane.

### Gels

In another aspect, an embodiment provides a gel comprising a polyazole and one or more of methane sulfonic acid sulfonic acid, trifluoromethane sulfonic acid, trifluoromethane carboxylic acid, benzene sulfonic acid, chloro-sulfonic acid, and fluoro-sulfonic acid. This gel may also be referred to, for example, as a polyazole-methane sulfonic acid gel or the like, depending upon the acid or acids used. The polyazole-methane sulfonic acid gel is a polyazole-acid gel intermediate in a method of making a fuel cell polyazole membrane as described above. In some embodiments, the polyazole comprises one or more of polybenzimidazole, polyimidazole, polybenzothiazole, polybenzoxazole, polyoxadiazole, polyquinoxaline, polythiadiazole, polypyridine, polypyrimidine, and polytetrazapyrene. The polyazole may also comprise one or more of poly(2,2′-(1,4-phenylene)-5,5′-bibenzimidazole), poly(2,2′-(1,3-phenylene)-5,5′-bibenzimidazole), or poly(2,5-benzimidazole), and/or any of the other polyazoles listed otherwise herein. In certain embodiments, the polyazole is polybenzimidazole. The polyazole-methane sulfonic acid gel may further comprise water.

Another embodiment provides a gel consisting essentially of a polyazole and water. A “gel consisting essentially of a polyazole and water” refers to a gel containing polyazole, water and optionally additional elements that do not affect the basic and novel characteristics of the polyazole-water gel as a useful intermediate in making a fuel cell polyazole membrane. In some embodiments, the polyazole comprises one or more of polybenzimidazole, polyimidazole, polybenzothiazole, polybenzoxazole, polyoxadiazole, polyquinoxaline, polythiadiazole, polypyridine, polypyrimidine, and polytetrazapyrene. In certain embodiments, the polyazole is polybenzimidazole. The polyazole may also comprise poly(2,2′-(1,4-phenylene)-5,5′-bibenzimidazole), poly(2,2′-(1,3-phenylene)-5,5′-bibenzimidazole), or poly(2,5-benzimidazole), or any of the other polyazoles described herein.

It will be understood that various embodiments of methods for forming fuel cell membranes and intermediate materials used in forming fuel cell membranes are exemplary in nature, and that these specific embodiments or examples are not to be considered in a limiting sense, because numerous variations are possible. The subject matter of the present disclosure includes all novel and nonobvious combinations and subcombinations of the various processes, systems and configurations, and other features, functions, acts, and/or properties disclosed herein, as well as any and all equivalents thereof.

What is claimed is:

1. A method of making a fuel cell polyazole membrane comprising:
a. dissolving a polyazole with a water stable polyazole solubilizing acid thereby forming a polyazole-acid solution,
b. applying a layer of said polyazole-acid solution to a support thereby forming a polyazole-acid film;
c. contacting said polyazole-acid film with water thereby forming a polyazole-acid gel; and
d. contacting said polyazole-acid gel with a doping acid thereby forming said fuel cell polyazole membrane.

2. The method of claim 1, wherein said doping acid comprises one or more of phosphoric acid and sulfuric acid.

3. The method of claim 1, wherein said polyazole comprises one or more of polybenzimidazole, polyimidazole, polytriazole, polypyrazine, polypyrimidine, polytetrapyrene, polyoxazole, polyindazole, polyisoxazole, polyisothiazole, polybenzothiazole, polybenzoxazole, polybenzoxadiazole, polyoxadiazole, polypyrazole, polyquinoxaline, quinoxazoline, polythiadiazole, polypyridine, polytetrazapyrene, poly(2,2′-(1,4-phenylene)-5,5′-bibenzimidazole), poly(2,2′-(1,3-phenylene)-5,5′-bibenzimidazole), and poly(2,5-benzimidazole).

4. The method of claim 1, wherein said polyazole comprises polybenzimidazole.

5. The method of claim 1, wherein said water stable polyazole solubilizing acid comprises one or more of sulfonic acid, methane sulfonic acid, trifluoromethane sulfonic acid, trifluoromethane carboxylic acid, benzene sulfonic acid, chloro-sulfonic acid, and fluoro-sulfonic acid.

6. The method of claim 1, wherein said water stable polyazole solubilizing acid comprises methane sulfonic acid.

7. The method of claim 1, wherein said polyazole-acid solution is formed at a temperature below 200° C.

8. The method of claim 1, wherein said support is a glass support or a polymer support.

9. A method of making a fuel cell polyazole membrane comprising:
a. dissolving a polyazole with a water stable polyazole solubilizing acid thereby forming a polyazole-acid solution;
b. applying a layer of said polyazole-acid solution to a support thereby forming a polyazole-acid film;
c. contacting said polyazole-acid film with water thereby forming a polyazole-acid gel;
d. flushing said polyazole-solubilizing acid from said polyazole-acid gel with water thereby forming a polyazole-water gel;
e. contacting said polyazole-water gel with a doping acid thereby forming said fuel cell polyazole membrane.

10. The method of claim 9, wherein said doping acid comprises one or more of phosphoric acid and sulfuric acid.

11. The method of claim 9, wherein said polyazole comprises one or more of polybenzimidazole, polyimidazole, polytriazole, polypyrazine, polypyrimidine, polytetrapyrene, polyoxazole, polyindazole, polyisoxazole, polyisothiazole, polybenzothiazole, polybenzoxazole, polybenzoxadiazole, polyoxadiazole, polypyrazole, polyquinoxaline, quinoxazoline, polythiadiazole, polypyridine, polytetrazapyrene, poly(2,2′-(1,4-phenylene-5,5′-bibenzimidazole), poly(2,2′-(1,3-phenylene-5,5′-bibenzimidazole), and poly(2,5-benzimidazole).

12. The method of claim 9, wherein said water stable polyazole solubilizing acid has a pKa from 0 to −14.

13. The method of claim 9, wherein said polyazole comprises polybenzimidazole.

14. The method of claim 9, wherein said water stable polyazole solubilizing acid comprises one or more of sulfonic acid, methane sulfonic acid, trifluoromethane sulfonic acid, trifluoromethane carboxylic acid, benzene sulfonic acid, chloro-sulfonic acid, and fluoro-sulfonic acid.

15. The method of claim 9, wherein said water stable polyazole solubilizing acid comprises methane sulfonic acid.

16. The method of claim 9, wherein said polyazole-acid solution is formed at a temperature of below 200° C.

17. The method of claim 9, wherein said support is a glass support or a polymer support.

18. A gel comprising a polyazole and one or more of sulfonic acid, methane sulfonic acid, trifluoromethane sulfonic acid, trifluoromethane carboxylic acid, benzene sulfonic acid, chloro-sulfonic acid, and fluoro-sulfonic acid.

19. The gel of claim 18 further comprising water.

20. The gel of claim 18, wherein said polyazole comprises one or more of wherein said polyazole comprises one or more of polybenzimidazole, polyimidazole, polytriazole, polypyrazine, polypyrimidine, polytetrapyrene, polyoxazole, polyindazole, polyisoxazole, polyisothiazole, polybenzothiazole, polybenzoxazole, polybenzoxadiazole, polyoxadiazole, polypyrazole, polyquinoxaline, quinoxazoline, polythiadiazole, polypyridine, polytetrazapyrene, poly(2,2′-(1,4-phenylene)-5,5′-bibenzimidazole), poly(2,2′-(1,3-phenylene)-5,5′bibenzimidazole), and poly(2,5-benzimidazole).
